(19) United States
(12) Patent Application Publication
(10) Pub. No.: US 2026/0120250 A1
(43) Pub. Date: Apr. 30, 2026

(54) LOW-DOSE COMPUTED TOMOGRAPHY DENOISING NEURAL NETWORK APPARATUS AND METHOD

(71) Applicant: UIF (UNIVERSITY INDUSTRY FOUNDATION), YONSEI UNIVERSITY, Seoul (KR)

(72) Inventors: Jongduk Baek, Incheon (KR); Seongjun Kim, Seoul (KR)

(73) Assignee: UIF (UNIVERSITY INDUSTRY FOUNDATION), YONSEI UNIVERSITY, Seoul (KR)

(21) Appl. No.: 18/934,185

(22) Filed: Oct. 31, 2024

(30) Foreign Application Priority Data
Oct. 30, 2024 (KR) 10-2024-0151585

(51) Int. Cl. G06T 5/70; G06T 5/60

(52) U.S. Cl. CPC G06T 5/70; G06T 5/60; G06T 2207/10081; G06T 2207/20081; G06T 2207/20084

(57) ABSTRACT

The present disclosure relates to a low-dose computed tomography denoising neural network apparatus, wherein the apparatus comprises a dose-aware network unit that provides an LDCT image as an input image to a convolutional neural network (CNN) and outputs a simulated normal-dose computed tomography (NDCT) image as an output image, a noise variance calibration unit that performs noise-variance calibration on the input image fed to the CNN to address the oversmoothing issue of the CNN, and an adaptive noise reduction unit that controls the CNN to progressively remove the noise according to the dose level of a given LDCT image.

### CROSS-REFERENCE TO RELATED APPLICATION

This application claims under 35 U.S.C. § 119 (a) the benefit of Korean Patent Application No. 10-2024-0151585 filed on Oct. 30, 2024, the entire contents of which is incorporated herein by reference.

### TECHNICAL FIELD

The present disclosure relates to a low-dose computed tomography denoising technology and, more specifically, to low-dose computed tomography denoising neural network apparatus and method, which may improve the quality of low-dose computed tomography (LDCT) images by effectively removing noise, thereby providing image quality comparable to that of normal-dose computed tomography (NDCT).

### BACKGROUND

Computed Tomography (CT) is an important medical imaging technique widely used to diagnose the disease of a patient. However, patients are exposed to radiation during CT scans, which incurs potential risks to patients. As a representative method to mitigate the risks, low-dose computed tomography (LDCT) has been introduced, which uses a reduced X-ray dose to capture images.

However, although scanning with low-dose computed tomography (LDCT) reduces radiation exposure, it may increase image noise, which may interfere with accurate diagnosis by medical staff. Compared to normal-dose computed tomography (NDCT), increased noise in LDCT images may make it difficult to identify anatomical structures.

To address the issue above, denoising techniques using deep learning-based convolutional neural networks (CNNs) are being developed. CNN-based denoising enables fast image processing but requires a large amount of data from LDCT and NDCT images for effective training. Since acquiring both types of images from a single patient is difficult, a method of simulating LDCT images based on NDCT images for training purposes is often employed.

However, a generalization problem may occur where performance is degraded for data with noise levels different from those used in training. To overcome the problem, additional training (fine-tuning) is required, which inevitably requires extra data and time, limiting its use.

Korean Patent Publication No. 10-2022-0135683 (Oct. 7, 2022) provides a noise reduction apparatus for LDCT images that may reduce noise without introducing blur or changing pixel values in LDCT images, along with a learning apparatus and method for the noise reduction apparatus.

A LDCT image noise reduction apparatus is implemented with a pre-trained artificial neural network and includes a denoising neural network that removes noise from an input LDCT image according to a learned method to output a denoising CT image, wherein the denoising neural network may apply a denoised CT image that is output from a LDCT image fed to a lesion identification neural network, which is an artificial neural network pre-trained to identify an image revealing lesion during the training stage, and a NDCT image, respectively; train the lesion identification neural network to reduce the observation loss calculated from the difference between a first feature map and a second feature map obtained from the lesion identification process using the denoised CT image and the NDCT image; and effectively reduce the noise without introducing blur or changing pixel values in the LDCT image.

### PRIOR ART REFERENCES

### Patent Document

Korean patent publication No. 10-2022-0135683 (Oct. 7, 2022)

### DESCRIPTION

### Problem to be Solved

One embodiment of the present disclosure provides a low-dose computed tomography denoising neural network apparatus and method, which may improve the quality of low-dose computed tomography (LDCT) images by effectively removing noise, thereby providing image quality comparable to that of normal-dose computed tomography (NDCT).

One embodiment of the present disclosure provides a low-dose computed tomography denoising neural network apparatus and method, which may produce a simulated image comparable to a normal-dose computed tomography (NDCT) image by analyzing the dose level of a low-dose computed tomography (LDCT) image and pre-generating LDCT images at varying dose levels.

One embodiment of the present disclosure provides a low-dose computed tomography denoising neural network apparatus and method, which includes a noise variance calibration unit that prevents the oversmoothing issue in CNNs to effectively remove the noise from low-dose computed tomography (LDCT) images.

### Solution

Among embodiments, a low-dose computed tomography (LDCT) denoising neural network apparatus comprises a dose-aware network unit that provides an LDCT image as an input image to a convolutional neural network (CNN) and outputs a simulated normal-dose computed tomography (NDCT) image as an output image, a noise variance calibration unit that performs noise-variance calibration on the input image fed to the CNN to address the oversmoothing issue of the CNN, and an adaptive noise reduction unit that controls the CNN to progressively remove the noise according to the dose level of a given LDCT image.

The dose-aware network unit may pre-generate the LDCT image configured to have varying dose levels by adding noise to an NDCT image. The dose-aware network unit may generate the varying dose levels by adjusting the intensity of the noise by controlling an alpha parameter of the NDCT image. The dose-aware network unit may train the CNN to minimize the discrepancy between the NDCT image and the simulated NDCT image.

The noise variance calibration unit may adjust the noise so that the detailed structure of the input image is preserved, based on the discrepancy between the output image and the input image. The noise variance calibration unit may adjust the noise so that the output image has a noise variance higher than or equal to that of the NDCT image by a threshold.

The adaptive noise reduction unit may recognize the dose level of the given LDCT image through the CNN and progressively remove the noise by performing repeated input/output operation through the CNN. The adaptive noise reduction unit may input an N-th (where N is a natural number) intermediate image to the CNN to generate an (N+1)-th intermediate image and again input the (N+1)-th intermediate image to the CNN to generate an (N+2)-th intermediate image.

Among embodiments, a low-dose computed tomography (LDCT) denoising neural network method performed in a LDCT denoising neural network apparatus comprises a dose-aware network step that provides an LDCT image as an input image to a convolutional neural network (CNN) and outputs a simulated normal-dose computed tomography (NDCT) image as an output image, a noise variance calibration step that performs noise-variance calibration on the input image fed to the CNN to address the oversmoothing issue of the CNN, and an adaptive noise reduction step that controls the CNN to progressively remove the noise according to the dose level of a given LDCT image.

### Effect

The present disclosure may provide the following effects. However, since it is not meant that a specific embodiment has to provide all of or only the following effects, the technical scope of the present disclosure should not be regarded as being limited by the specific embodiment.

A low-dose computed tomography denoising neural network apparatus and method according to one embodiment of the present disclosure may improve the quality of low-dose computed tomography (LDCT) images by effectively removing noise, thereby providing image quality comparable to that of normal-dose computed tomography (NDCT).

A low-dose computed tomography denoising neural network apparatus and method according to one embodiment of the present disclosure may produce a simulated image comparable to a normal-dose computed tomography (NDCT) image by analyzing the dose level of a low-dose computed tomography (LDCT) image and pre-generating LDCT images at varying dose levels.

A low-dose computed tomography denoising neural network apparatus and method according to one embodiment of the present disclosure may include a noise variance calibration unit that prevents the oversmoothing issue in CNNs to effectively remove the noise from low-dose computed tomography (LDCT) images.

### BRIEF DESCRIPTION OF THE DRAWINGS

FIG. 1 illustrates the structure of a low-dose computed tomography denoising neural network apparatus according to one embodiment of the present disclosure.

FIG. 2 illustrates the system structure of the low-dose computed tomography denoising neural network apparatus 100 of FIG. 1.

FIG. 3 illustrates processes of training and testing a network for removing noise in LDCT images of the low-dose computed tomography denoising neural network apparatus of FIG. 1.

FIG. 4 illustrates a noise removal method for LDCT images by comparing an existing method with the method proposed in the present disclosure.

FIG. 5 is a flow diagram illustrating the operation of the low-dose computed tomography denoising neural network apparatus of FIG. 1.

FIG. 6 illustrates CT images from Mayo dataset with varying dose conditions (25%, 10%, 5%) reconstructed using the low-dose computed tomography denoising neural network apparatus of FIG. 1, where each column shows results from different networks and reconstruction methods.

FIG. 7 illustrates the result of ablation study conducted to evaluate the effect of the noise-variance calibration (NCM) module of the low-dose computed tomography denoising neural network apparatus of FIG. 1.

### DETAILED DESCRIPTION

Specific structural or functional descriptions in the embodiments of the present disclosure introduced in this specification or application are only for description of the embodiments of the present disclosure. The descriptions should not be construed as being limited to the embodiments described in the specification or application. The present disclosure may, however, be embodied in many different forms, but should be construed as covering modifications, equivalents or alternatives falling within ideas and technical scopes of the present disclosure. Further, since effects disclosed herein do not mean that a specific embodiment should include all or only the effects, the scope of the present disclosure should not be construed as being limited thereto.

Meanwhile, the meaning of terms described herein will be understood as follows.

It will be understood that, although the terms “first”, “second”, etc. may be used herein to distinguish one element from another element, these elements should not be limited by these terms. For instance, a first element discussed below could be termed a second element without departing from the teachings of the present disclosure. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to” or “directly adjacent to” should be construed in the same way.

In the present disclosure, the singular forms are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

In each step, reference characters (e.g. a, b, c, etc.) are used for the convenience of description. The reference characters do not designate the order of the steps, and the steps may be performed in a different order unless the context clearly indicates otherwise. That is, the steps may be performed in the specified order, may be performed substantially simultaneously, or may be performed in a reverse order.

The present disclosure can be implemented as a computer-readable code on a computer-readable recording medium. The computer-readable recording medium includes all types of recording devices in which data readable by a computer system is stored. Examples of the computer-readable recording medium include ROM, RAM, CD-ROM, magnetic tape, floppy disk, an optical data storage device, etc. In addition, the computer-readable recording medium may be distributed in a computer system connected via a network, so that computer-readable codes may be stored and executed in a distributed manner.

Unless otherwise defined, all terms including technical and scientific terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

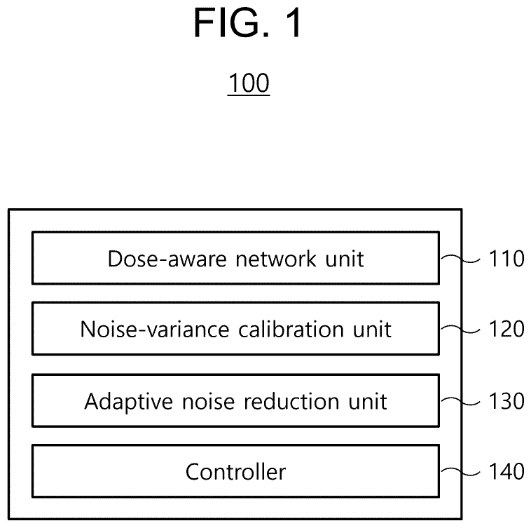

FIG. 1 illustrates the structure of a low-dose computed tomography denoising neural network apparatus according to one embodiment of the present disclosure.

Referring to FIG. 1, the low-dose computed tomography denoising neural network apparatus 100 may receive a low-dose computed tomography (LDCT) image, outputs a simulated normal-dose computed tomography (NDCT) image through a convolutional neural network (CNN), and effectively remove noise at each process step through noise-variance calibration and adaptive noise reduction; and include a dose-aware network unit 110, a noise variance calibration unit 120, an adaptive noise reduction unit 130, and a controller 140.

The low-dose computed tomography denoising neural network apparatus 100 is an apparatus for generating a high quality image comparable to a normal dose CT (NDCT) image by effectively removing noise from a low-dose CT (LDCT) image. The apparatus may reduce data requirements and provide generalized performance by synthesizing LDCT images with varying dose levels using only NDCT images to learn the unique noise characteristics of LDCT images through the convolutional neural network (CNN). In particular, to address the oversmoothing problem, the apparatus 100 may apply a noise-variance calibration technique to mathematically adjust the noise so that the CNN output maintains the noise variance similar to that of the NDCT image.

LDCT images require a neural network-based denoising method because noise tends to increase in the image while radiation exposure is reduced. However, when the network attempts to generate LDCT images similar to high-quality NDCT images, oversmoothing (excessive equalization) may occur, leading to a loss of image details. This may be a significant issue in medical images where preservation of anatomical structure is crucial.

To address the oversmoothing problem, the noise difference between the CNN output and the NDCT target image is quantified and compensated for using the Noisier2Noise theory, enabling the network to achieve optimal denoising performance.

### Oversmoothing

First, an NDCT image may be represented by x_{ND}=x+n.

Here, x represents the original CT image without noise, and n represents the noise with a variance of σ². Through the model, an independent noise ñ with the same distribution and variance may be generated, and an LDCT image may be expressed by Eq. 1 below.

$${x}_{LD} = {x}_{ND} + α \tilde{n} \qquad [ Eq . 1 ]$$

Here, α represents an adjustable parameter and reflects varying noise levels. At this time, the noise variance of the LDCT image is (1+α²)σ².

When the optimal output of the CNN is defined as E[x_{ND}|x_{LD}], Eq. 5 may be finally derived as follows.

First, when the mean squared error (MSE) loss function is used for network training, Eqs. 2 and 3 are satisfied.

$$[ {x}_{ND} \vert {x}_{LD} ] = [ x \vert {x}_{LD} ] + [ n \vert {x}_{LD} ] \qquad [ Eq . 2 ]$$

$$[ \tilde{n} \vert {x}_{LD} ] = α [ n \vert {x}_{LD} ] \qquad [ Eq . 3 ]$$

Mathematical manipulations are performed as shown in Eq. 4 by utilizing Eqs. 2 and 3.

$$\begin{matrix}( 1 + {α}^{2} ) 𝔼 [ {x}_{ND} \vert {x}_{LD} ] = {α}^{2} 𝔼 [ x \vert {x}_{LD} ] + ( 𝔼 [ x \vert {x}_{LD} ] + 𝔼 [ n \vert {x}_{LD} ] + {α}^{2} 𝔼 [ n \vert {x}_{LD} ] ) \\ = {α}^{2} 𝔼 [ x \vert {x}_{LD} ] + ( 𝔼 [ x \vert {x}_{LD} ] + 𝔼 [ n \vert {x}_{LD} ] + {α}^{2} 𝔼 [ \tilde{n} \vert {x}_{LD} ] ) \\ = {α}^{2} 𝔼 [ x \vert {x}_{LD} ] + 𝔼 [ x + n + α \tilde{n} \vert {x}_{LD} ] \\ = {α}^{2} 𝔼 [ x \vert {x}_{LD} ] + {x}_{LD}\end{matrix} \qquad [ Eq . 4 ]$$

By formulating the above equation, Eq. 5 is obtained.

$$𝔼 [ {x}_{ND} \vert {x}_{LD} ] = \frac{{α}^{2}}{1 + {α}^{2}} 𝔼 [ x \vert {x}_{LD} ] + \frac{1}{1 + {α}^{2}} {x}_{LD}$$

The Eq. 5 is a formula expressing E[x_{ND}|x_{LD}], which is the output of an optimized CNN. As the equation shows, the noise variance is obtained by multiplying the noise variance of the low-dose CT image x_{LD} by

$$\frac{1}{{( 1 + {α}^{2} )}^{2}} .$$

Since the noise variance of the low-dose CT image is (1+α²)σ², the noise variance of the CNN output becomes

$$\frac{1}{( 1 + {α}^{2} )} {σ}^{2} .$$

Since the obtained noise variance is smaller than the noise variance of the normal-dose CT image, σ², oversmoothing may occur.

In other words, as the value of a in the above equation increases, E[x_{ND}|x_{LD}] is smoothed against x_{LD}, which causes the CNN to fail to preserve the anatomical details of the NDCT image and produce an excessively smooth output. The oversmoothing may lead to a loss of anatomical details and generate an excessively smooth output.

The dose-aware network unit 110 is a constituting element that performs the function of inputting an LDCT image into the CNN and outputting a simulated NDCT image; to pre-generate an LDCT image with varying dose levels, noise is added to the NDCT image, where varying noise levels may be implemented by adjusting the intensity of the noise through controlling of the alpha parameter. Also, the dose-aware network unit 110 may provide more accurate denoising performance by training the CNN to minimize the difference between the NDCT image and the simulated NDCT image.

The dose-aware network 110 may be trained using only independent NDCT images x_{ND}, considering that data of LDCT and NDCT pairs are not always available in actual clinical practice. To this end, noise ñ that mimics the unique CT noise present in x_{ND} may be generated, and LDCT images reflecting varying radiation dose levels may be synthesized.

The LDCT image x_{LD,t} is generated through Eq. 6 below.

$${x}_{LD , t} = {x}_{ND} + {α}_{t} \tilde{n} , t ∈ [ 1 , T ] \qquad [ Eq . 6 ]$$

Here, T represents the total number of steps, and αₜ is an increasing series of numbers that adjust the dose level at each step.

This network may be trained according to an objective function, as shown in Eq. 7 below, to achieve the denoising goal of mapping LDCT images with varying dose levels to NDCT images.

$${min}_{θ} {‖ f ( {x}_{LD , t} , θ , t ) - {x}_{ND} ‖}_{2} \qquad [ Eq . 7 ]$$

Here, ƒ(⋅, θ, t) is a CNN with a trainable parameter θ at step t. In this way, the CNN learns noise reduction at various dose levels and achieves generalization performance for various dose levels when T>1. Through the process above, the dose-aware network unit 110 may effectively provide simulated NDCT images for LDCT images at various dose levels.

The noise variance calibration unit 120 is a constituting element that adjusts noise variance to address the oversmoothing issue of the CNN and preserve the detailed structure of an input image; the noise variance calibration unit 120 may adjust noise based on the difference between the output image of the CNN and the input image so that anatomical details of the image are retained. At this time, by controlling the calibrated output image to maintain a noise variance similar to that of the NDCT image, noise removal and preservation of a detailed structure may be achieved simultaneously in the final image.

The noise variance calibration unit 120 may use a method of calibrating the output image of the CNN by introducing calibration coefficient βt to maintain a noise-variance level similar to that of the NDCT image. At this time, the calibration equation may be defined by Eq. 8 below.

$${\hat{x}}_{output} = f ( {x}_{LD , t} , θ , t ) + {β}_{t} ( {x}_{LD , t} - f ( {x}_{LD , t} , θ , t ) ) \qquad [ Eq . 8 ]$$

Here, ƒ(x_{LD}, θ, t) represents the output image of CNN, \hat{x}ₒᵤₜₚᵤₜ represents the calibrated output image, and βₜ represents the calibration coefficient, where βₜ>0; the coefficient βₜ is configured so that the noise variance of \hat{x}ₒᵤₜₚᵤₜ matches the noise variance of the NDCT image.

Through the calibration process, the noise variance of \hat{x}ₒᵤₜₚᵤₜ is adjusted to be similar to that of the NDCT image, and the coefficient βₜ may be derived mathematically based on Noiser2Noise theory.

Finally, the objective function of network training according to the proposed method may be defined by Eq. 9 below.

$${min}_{θ} {‖ f ( {x}_{LD , t} , θ , t ) - {x}_{ND} ‖}_{2} + λ ( 1 - SSIM ( {\hat{x}}_{output} , {x}_{ND} ) ) \qquad [ Eq . 9 ]$$

Here, SSIM is a structural similarity index measure (SSIM) loss, and λ is the weighting parameter of the SSIM loss.

Through the noise variance calibration, the noise variance calibration unit 120 may improve the denoising performance of the LDCT image while maintaining structural consistency similar to that of the NDCT image.

The adaptive noise reduction unit 130 is a constituting element that recognizes the dose level of an LDCT image and progressively reduces noise through repeated application of a CNN. The adaptive noise reduction unit 130 first inputs the LDCT image into the CNN to generate a first intermediate image, and then iteratively inputs the generated intermediate image back into the CNN to generate the next intermediate image at subsequent steps. This iterative process may gradually reduce the noise in the LDCT image and ultimately provide an output with quality comparable to that of an NDCT image. The adaptive noise reduction unit 130 may effectively mitigates the high noise level observed in the LDCT image by reducing noise while preserving the detailed structure of the image at each iteration step.

The adaptive noise reduction unit 130 may perform denoising by utilizing the optimal CNN parameter θ* corresponding to a specific dose step t′ to reduce noise in an optimal manner according to the dose level of the LDCT image. To this end, the adaptive noise reduction unit 130 may employ a method that calibrates the output of the CNN at each intermediate step and progressively removes noise by applying Eq. 10 below.

$${y}_{t - 1} = f ( {y}_{t} , {θ}^{*} , t ) + {γ}_{t} ( {y}_{t} - f ( {y}_{t} , {θ}^{*} , t ) ) \qquad [ Eq . 10 ]$$

Here, t starts from the initial step t′ and proceeds in reverse to step 1, and yₜ represents the denoising result at the intermediate step. The calibration coefficient γₜ is calculated in a manner similar to βₜ, through which the accuracy of noise reduction at each step may be improved.

The iterative denoising method may effectively reduce noise while preserving more detailed image structure compared to a single-step approach, thereby further improving the resolution and quality of the final result.

### Noise Calibration

Noise calibration is the process of adjusting the output noise variance of a CNN to match that of an NDCT image to address the oversmoothing problem that occurs during the denoising of an LDCT image. LDCT images inherently contain high-intensity noise while providing reduced radiation exposure, which may compromise anatomical details; therefore, denoising using a CNN is necessary. However, if the network applies excessive equalization (oversmoothing), anatomical details may be lost, leading to deterioration in image quality.

### 1. Noise Calibration Equation and Process

The optimized output E[x_{ND}|X_{LD,t}] of the CNN, used for training to target NDCT images, may be defined by the following equation:

$$E [ {x}_{ND} \vert {x}_{LD , t} ] = \frac{{α}_{t}^{2}}{1 + {α}_{t}^{2}} E [ x \vert {x}_{LD , t} ] + \frac{1}{1 + {α}_{t}^{2}} {x}_{LD , t} .$$

Here, E[x_{ND}|x_{LD,t}] is approximated by x+ϵ, where ϵ is a noise-free residual error. Through the equation, the output value ƒ(x_{LD,t}, θ, t) of the CNN may be derived by Eq. 11 below.

$$\begin{matrix}f ( {x}_{LD , t} , θ , t ) = \frac{{α}_{t}^{2}}{1 + {α}_{t}^{2}} ( x + ϵ ) + \frac{1}{1 + {α}_{t}^{2}} ( x + n + {α}_{t} \tilde{n} ) \\ = x + \frac{1}{1 + {α}_{t}^{2}} n + \frac{{α}_{t}}{1 + {α}_{t}^{2}} \tilde{n} + {ϵ}^{′}\end{matrix} \qquad [ Eq . 11 ]$$

### 2. Calculation of Calibration Output

The noise variance calibration unit may generate a calibrated output \hat{x}ₒᵤₜₚᵤₜ, which provides image quality similar to that of the NDCT image. The calibrated output may be calculated by Eq. 12 below.

$$\begin{matrix}{\hat{x}}_{output} = f ( {x}_{LD , t} , θ , t ) + {β}_{t} ( {x}_{LD , t} - f ( {x}_{LD , t} , θ , t ) ) \\ = ( x + \frac{1}{1 + {α}_{t}^{2}} n + \frac{{α}_{t}}{1 + {α}_{t}^{2}} \tilde{n} + {ϵ}^{′} ) + \\ = {β}_{t} ( x + n + {α}_{t} \tilde{n} - x - \frac{1}{1 + {α}_{t}^{2}} n - \frac{{α}_{t}}{1 + {α}_{t}^{2}} \tilde{n} - {ϵ}^{′} ) \\ = x + \frac{1 + {α}_{t}^{2} {β}_{t}}{1 + {α}_{t}^{2}} n + \frac{{α}_{t} ( 1 + {α}_{t}^{2} {β}_{t} )}{1 + {α}_{t}^{2}} \tilde{n} + {ϵ}^{′′}\end{matrix} \qquad [ Eq . 12 ]$$

### 3. Noise Variance Condition

Due to the independent and identically distributed relationship between noises n and ñ, the noise variance of the calibrated output\hat{ }ₒᵤₜₚᵤₜ may be calculated by Eq. 13 as follows.

$$\begin{matrix}var ( {\hat{x}}_{output} ) = var ( x + \frac{1 + {α}_{t}^{2} {β}_{t}}{1 + {α}_{t}^{2}} n + \frac{{α}_{t} ( 1 + {α}_{t}^{2} {β}_{t} )}{1 + {α}_{t}^{2}} \tilde{n} + {ϵ}^{′′} ) \\ = var ( \frac{1 + {α}_{t}^{2} {β}_{t}}{1 + {α}_{t}} n + \frac{{α}_{t} ( 1 + {α}_{t}^{2} {β}_{t} )}{1 + {α}_{t}^{2}} \tilde{n} ) \\ = \{ {( \frac{1 + {α}_{t}^{2} {β}_{t}}{1 + {α}_{t}^{2}} )}^{2} + {{α}_{t}^{2} ( \frac{1 + {α}_{t}^{2} {β}_{t}}{1 + {α}_{t}^{2}} )}^{2} \} {σ}^{2}\end{matrix} \qquad [ Eq . 13 ]$$

Since the noise variance of the NDCT image is σ², the following condition may be established.

$${( \frac{1 + {α}_{t}^{2} {β}_{t}}{1 + {α}_{t}^{2}} )}^{2} + {{α}_{t}^{2} ( \frac{1 + {α}_{t}^{2} {β}_{t}}{1 + {α}_{t}^{2}} )}^{2} = 1$$

Through the condition above, the calibration coefficient βₜ may be calculated as follows.

$${β}_{t} = \frac{1}{{α}_{t}^{2}} ( \sqrt{1 + {α}_{t}^{2}} - 1 )$$

Through the calibration process, the final output may produce LDCT images with quality comparable to that of NDCT images while maintaining the inherent noise variance of the LDCT image.

The controller 140 may manage the overall control operation of the low-dose computed tomography denoising neural network apparatus 100 and manage the control flow or data flow between the dose-aware network unit 11θ, the noise variance calibration unit 120, and the adaptive noise reduction unit 130.

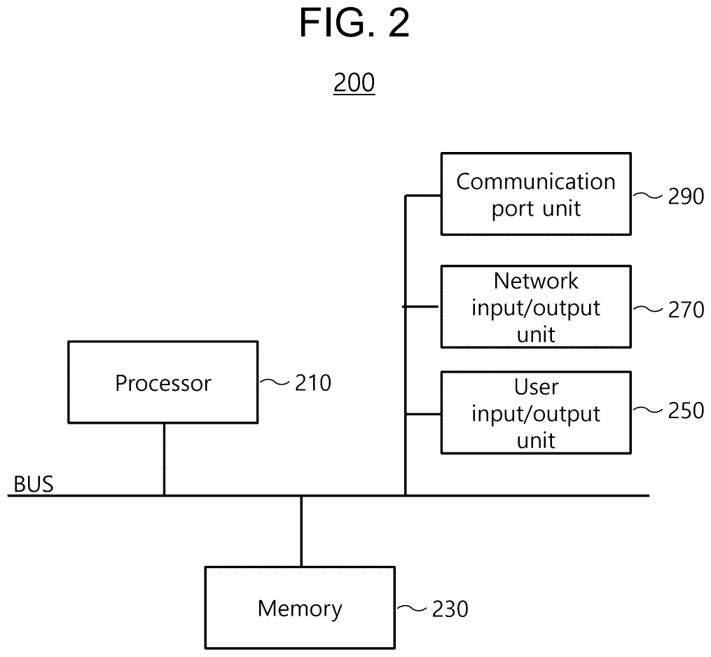

FIG. 2 illustrates the system structure of the low-dose computed tomography denoising neural network apparatus 100 of FIG. 1.

Referring to FIG. 2, the low-dose computed tomography denoising neural network apparatus 100 may include a processor 210, a memory 230, a user input/output unit 250, a network input/output unit 270, and a communication port unit 290.

The processor 210 may execute a low-dose computed tomography denoising neural network procedure according to an embodiment of the present disclosure, manage a memory 230 that is read or written in this process, and schedule a synchronization time between a volatile memory and a non-volatile memory in the memory 230. The processor 210 may control the overall operation of the low-dose computed tomography denoising neural network apparatus 100 and may be electrically connected to the memory 230, the user input/output unit 250, the network input/output unit 270, and the communication port unit 290 to control the data flow among them. The processor 210 may be implemented as a Central Processing Unit (CPU) or a Graphics Processing Unit (GPU) of the low-dose computed tomography denoising neural network apparatus 100.

The memory 230 may include an auxiliary memory device, implemented as a non-volatile memory such as a Solid State Disk (SSD) or a Hard Disk Drive (HDD) and used to store all data required for the low-dose computed tomography denoising neural network apparatus 100, and a main memory device implemented as a volatile memory such as a Random Access Memory (RAM). Also, the memory 230 may store a set of commands that, when executed by the electrically connected processor 210, execute the low-dose computed tomography denoising neural network apparatus and method according to the present disclosure.

The user input/output unit 250 includes an environment for receiving user input and an environment for outputting specific information to the user, which may include, for example, an input device including an adapter such as a touch pad, a touch screen, a virtual keyboard, or a pointing device and an output device including an adapter such as a monitor or a touch screen. In one embodiment, the user input/output unit 250 may correspond to a computing device connected via remote access, and in such a case, the low-dose computed tomography denoising neural network apparatus 100 may be operated as an independent server.

The network input/output unit 270 provides a communication environment for connecting to the user terminal via a network, which may include, for example, an adapter for communication such as a Local Area Network (LAN), a Metropolitan Area Network (MAN), a Wide Area Network (WAN), and a Value Added Network (VAN). Also, the network input/output unit 270 may be implemented to provide a short-range communication function such as WiFi or Bluetooth or a wireless communication function of 4G or higher for wireless transmission of data.

The communication port unit 290 may be implemented as a port mapping table that performs data routing while transmitting and receiving data through a network. Here, the communication port unit 290 may identify a communication session between the dose-aware network unit 110 and a server by allocating a unique source port to the dose-aware network unit 110 and prevent data collision during the data transmission and reception process.

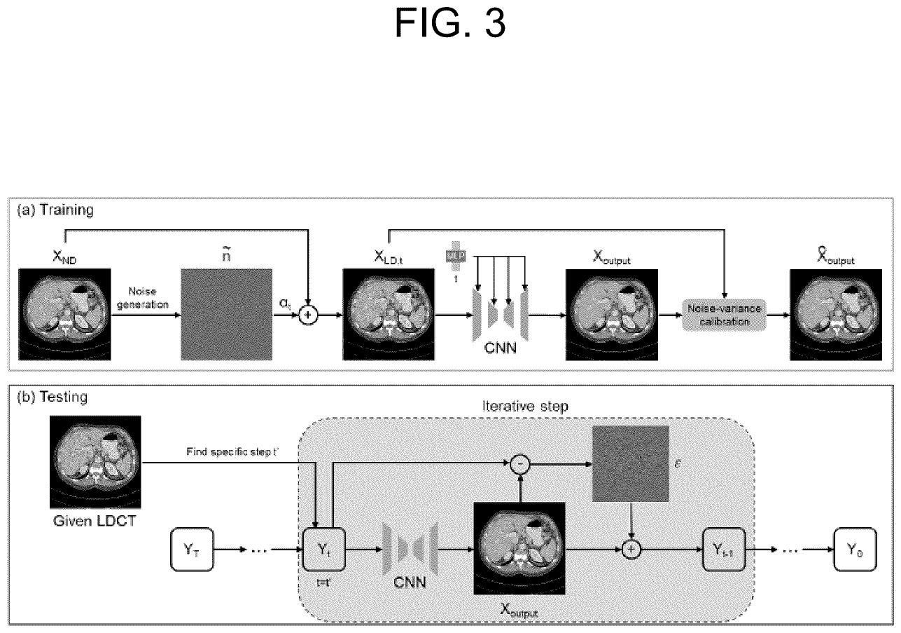

FIG. 3 illustrates processes of training and testing a network for removing noise in LDCT images of the low-dose computed tomography denoising neural network apparatus of FIG. 1.

Referring to FIG. 3, the low-dose computed tomography denoising neural network apparatus 100 may undergo several processes during the training and testing stages to remove noise from an LDCT image.

(a) In the training stage, an independent noise ñ may be added to the NDCT image x_{ND} through a noise generation module to generate LDCT images x_{LD,t} with varying noise levels. At this time, the parameter at may be adjusted to reflect varying noise intensities. The generated LDCT image is input to the CNN to generate an intermediate output image xₒᵤₜₚᵤₜ and then the noise-variance calibration module may adjust the noise level for this output to generate a final adjusted output xₒᵤₜₚᵤₜ· The calibration above is introduced to prevent the oversmoothing problem and to preserve the detailed structure of the LDCT image.

(b) In the testing stage, when a given LDCT image is input, denoising may be performed by selecting the optimal iteration step t′ that corresponds to the dose level of the LDCT image. Starting with setting the given LDCT image as yₜ′, the image is repeatedly input into the CNN, and noise may be progressively reduced using the calibration coefficient γₜ and the noise value at each step. Through the iterative process, when the final output y₀ is obtained, a high-quality denoising result comparable to that of the NDCT image may be provided.

The noise calibration and reduction processes of the low-dose computed tomography denoising neural network apparatus 100 may be described as follows.

### 1. Noise Calibration

During the training stage for denoising LDCT images, the network output tends to have a lower noise level than NDCT images, which may cause an oversmoothing problem. To solve the oversmoothing problem, the network output result and the LDCT image may be linearly combined using a mathematical formula to adjust the noise level to the same level as the NDCT image. Through the process above, the network makes both 1) the oversmoothed intermediate result and 2) the result with an adjusted noise level comparable to the NDCT image, enabling effective network training.

### 2. Noise Reduction

Since the network is trained to reduce noise across various dose levels, the network may perform noise reduction according to the noise level of the test data without involving an additional training process. During the testing stage, noise reduction is not completed in a single pass but may be achieved through iterative application of the network, progressively reducing noise at each iteration.

Specifically, when the trained network is initially applied to the test data, a first intermediate result is generated with noise at a lower level than the original test data. Then, the generated intermediate result and the test data are linearly combined to produce a result with a further reduced noise than the test data; the result is again used as input data, and the process above is iterated to finally obtain a high quality denoising result comparable to NDCT images.

The number of network applications is determined according to the initial noise level of the test data, and each iteration step may be designed to progressively reduce noise.

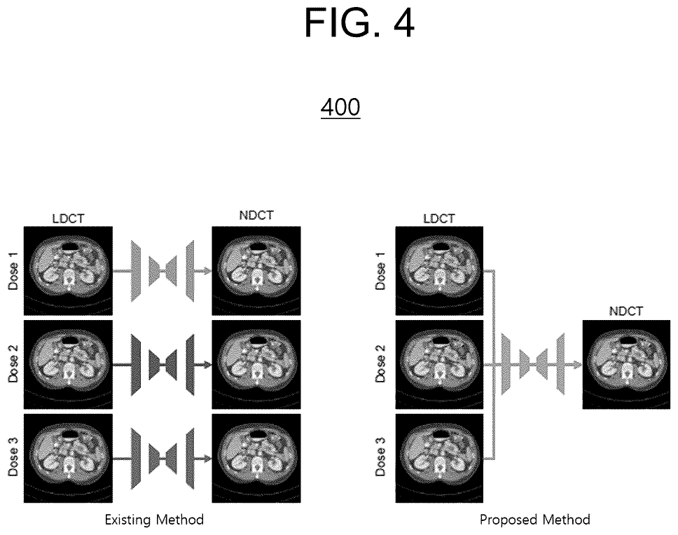

FIG. 4 illustrates a noise removal method for LDCT images by comparing an existing method with the method proposed in the present disclosure.

The left side of FIG. 4 illustrates the existing method, where LDCT images at different dose levels (Dose 1, Dose 2, Dose 3) are individually input into the network to generate simulated NDCT images optimized for each dose. While this method achieves denoising performance for specific dose levels, the network is trained separately for each dose, making it difficult to generalize performance; as a result, additional calibration is required during the testing stage.

The right side of FIG. 4 illustrates the dose-aware denoising network method proposed in the present disclosure, which is designed to process LDCT images at varying dose levels in a single network to provide general denoising performance. The proposed method may integrate LDCT images at varying dose levels into a single network for training. Through this approach, LDCT images at various dose levels are input into a common network and converted into simulated NDCT images, enabling the proposed method to provide generalized denoising performance across various dose levels using a single network.

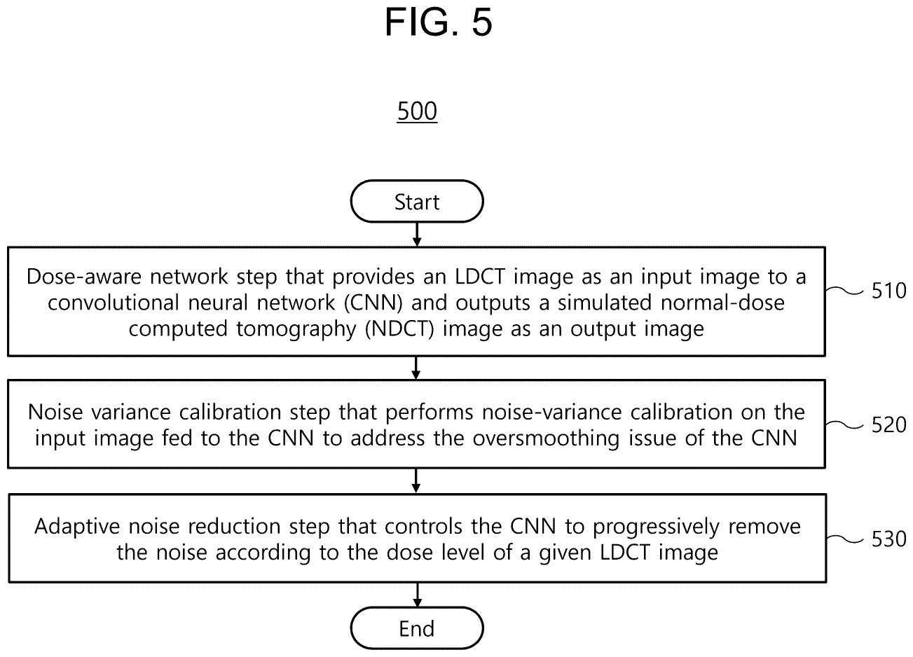

FIG. 5 is a flow diagram illustrating the operation of the low-dose computed tomography denoising neural network apparatus of FIG. 1.

Referring to FIG. 5, the flow diagram 500 of a low-dose computed tomography denoising neural network apparatus performs a dose-aware network step 510 that provides an LDCT image as an input image to a convolutional neural network (CNN) and outputs a simulated normal-dose computed tomography (NDCT) image as an output image, a noise variance calibration step 520 that performs noise-variance calibration on the input image fed to the CNN to address the oversmoothing issue of the CNN, and an adaptive noise reduction step 530 that controls the CNN to progressively remove the noise according to the dose level of a given LDCT image.

The dose-aware network step 510 includes a process of providing an LDCT image as an input image to a convolutional neural network (CNN) and outputs a simulated normal-dose computed tomography (NDCT) image as an output image. In this step, input LDCT images may be reconstructed to resemble high-dose CT images.

The noise variance calibration step 520 performs noise-variance calibration on the input image fed to the CNN to address the oversmoothing issue of the CNN. In this step, the output image of the CNN may be calibrated to match the noise variance level of the NDCT image to maintain the detailed structure.

The adaptive noise reduction step 530 includes a process of progressively removing noise according to the dose level of a given LDCT image. In this step, the noise reduction effect at each iteration is maximized to ultimately produce a high-quality image comparable to the NDCT image.

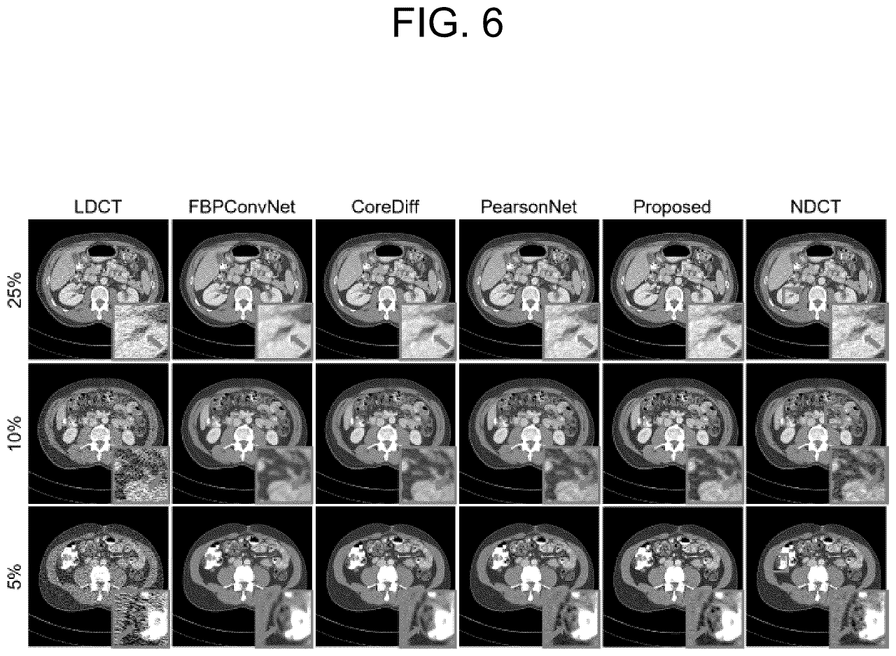

FIG. 6 illustrates CT images from Mayo dataset with varying dose conditions (25%, 10%, 5%) reconstructed using the low-dose computed tomography denoising neural network apparatus of FIG. 1, where each column shows results from different networks and reconstruction methods.

Referring to FIG. 6, each column of FIG. 5 is organized to visually compare the reconstruction performance by displaying results from LDCT, FBPConvNet, CoreDiff, PearsonNet, the proposed method according to the present closure, and NDCT from left to right.

The FBPConvNet and CoreDiff methods succeeded in effectively reducing noise but exhibited a tendency to excessively smooth anatomical structures compared to NDCT images. This oversmoothing phenomenon may result in the loss of fine anatomical details, which may increase the risk of missing critical information in medical diagnosis. On the other hand, the PearsonNet and the proposed methods effectively reduce noise while preserving a noise texture similar to that of NDCT images, thereby maintaining anatomical structures more accurately.

In particular, in FIG. 6, it may be observed that the proposed method reconstructs fine structures such as holes more clearly than the PearsonNet method in the region of interest (ROI) under the 5% dose condition. These results indicate that the low-dose computed tomography denoising neural network apparatus 100 proposed in the present disclosure may provide high-resolution denoising performance even under various low-dose conditions, thereby obtaining image quality comparable to NDCT images. Also, while the FBPConvNet, CoreDiff, and PearsonNet methods require separate network training for each dose condition, the proposed method demonstrates excellent generalization performance in that it may be applied to all dose conditions with a single network training.

Table 1 shows the results of quantitative performance comparison among different methods.

TABLE 1

| | 25% dose | | | 10% dose | | | 5% dose | | |
|---|---|---|---|---|---|---|---|---|---|
| | PSNR ↑ | SSIM ↑ | LPIPS ↓ | PSNR ↑ | SSIM ↑ | LPIPS ↓ | PSNR ↑ | SSIM ↑ | LPIPS ↓ |
| LDCT | 33.87 ± | 0.768 ± | 0.340 ± | 30.43 ± | 0.624 ± | 0.690 ± | 27.60 ± | 0.490 ± | 1.128 ± |
| | 2.06 | 0.062 | 0.100 | 2.06 | 0.086 | 0.179 | 2.07 | 0.097 | 0.265 |
| FBPConvNet | 39.01 ± | 0.905 ± | 0.179 ± | 38.48 ± | 0.896 ± | 0.201 ± | 38.04 ± | 0.889 ± | 0.214 ± |
| | 1.64 | 0.026 | 0.057 | 1.48 | 0.027 | 0.060 | 1.39 | 0.027 | 0.062 |
| CoreDiff | 38.71 ± | 0.900 ± | 0.148 ± | 38.35 ± | 0.894 ± | 0.169 ± | 37.98 ± | 0.888 ± | 0.182 ± |
| | 1.66 | 0.027 | 0.044 | 1.49 | 0.027 | 0.049 | 1.38 | 0.027 | 0.052 |
| PearsonNet | 37.58 ± | 0.876 ± | 0.138 ± | 37.24 ± | 0.867 ± | 0.155 ± | 36.59 ± | 0.852 ± | 0.165 ± |
| | 1.56 | 0.032 | 0.038 | 1.35 | 0.031 | 0.041 | 1.29 | 0.033 | 0.041 |
| Proposed | 37.97 ± | 0.887 ± | 0.136 ± | 37.60 ± | 0.880 ± | 0.149 ± | 37.20 ± | 0.873 ± | 0.159 ± |
| | 1.79 | 0.032 | 0.040 | 1.62 | 0.032 | 0.041 | 1.51 | 0.032 | 0.042 |

Table 1 above shows the results of numerical evaluation of reconstruction methods using performance indicators such as Peak Signal-to-Noise Ratio (PSNR), Structural Similarity Index Measure (SSIM), and Learned Perceptual Image Patch Similarity (LPIPS). While the FBPConvNet and CoreDiff methods score high in PSNR and SSIM, which are indices for noise reduction, they are sensitive to noise reduction performance, resulting in smooth results where anatomical details are actually lost. On the other hand, LPIPS is an index that reflects human perception and is more suitable for evaluating visual quality than PSNR or SSIM. The proposed method shows the highest LPIPS score across all dose conditions, demonstrating its excellent performance in terms of preserving details and texture.

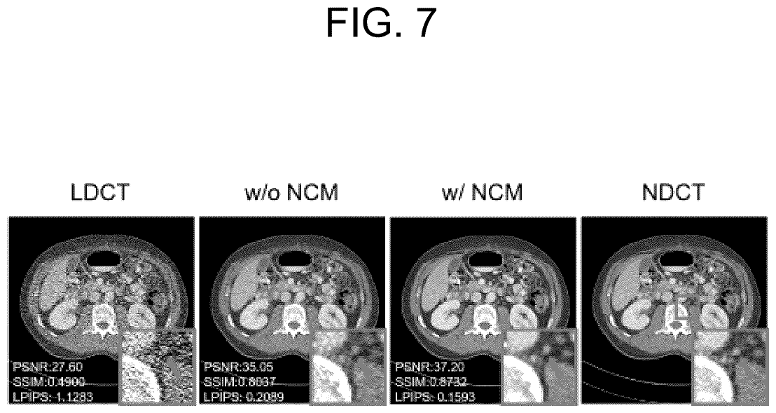

FIG. 7 illustrates the result of ablation study conducted to evaluate the effect of the noise-variance calibration (NCM) module of the low-dose computed tomography denoising neural network apparatus of FIG. 1.

Referring to FIG. 7, each column sequentially displays the results of LDCT, the method without applying NCM (w/o NCM), the method with NCM (w/NCM), and NDCT. In the LDCT image, the PSNR, SSIM, and LPIPS indices are low, and high noise levels and distorted anatomical structures are observed. The method without NCM (w/o NCM) reduces noise to some extent but still lacks clarity and shows a loss of details of anatomical structures. At this time, PSNR is 35.05, SSIM is 0.8937, and LPIPS is 0.2089; while noise is removed to some extent, the loss of anatomical details is observed.

On the other hand, the method applying NCM (w/NCM) effectively reduced noise while maintaining image quality comparable to NDCT images and better preserving detailed structures. The method applying NCM achieved PSNR of 37.20, SSIM of 0.8732, and LPIPS of 0.1593; notably, LPIPS index is low, which demonstrates improved visual quality. The results above suggest that NCM effectively calibrates the noise level to prevent oversmoothing and maintain textures comparable to those of NDCT images.

Also, the enlarged red box in FIG. 7 highlights the difference in the sharpness of fine tissue structures in the region of interest (ROI) based on whether NCM was applied; it demonstrates that the boundaries of anatomical structures are expressed more clearly when NCM is applied.

The low-dose computed tomography denoising neural network apparatus 100 proposed in the present disclosure may provide a denoising network that may be easily generalized to various dose levels. The apparatus is trained using only NDCT images and may include a noise-variance calibration module based on mathematical derivation to prevent excessive smoothing (oversmoothing) that may occur in the network output. After training, the trained network may be adaptively applied considering the dose level of the test dataset. As a result, the denoising neural network apparatus of the present disclosure may provide optimal performance that effectively preserves noise texture at various dose levels and achieves high visual quality.

Although the present disclosure has been described with reference to preferred embodiments given above, it should be understood by those skilled in the art that various modifications and variations of the present disclosure may be made without departing from the technical principles and scope specified by the appended claims below.

### [Acknowledgement]

[Project Serial No] 2710006677
[Project No] RS-2020-II201361
[Department] Ministry of Science and ICT
[Project management (Professional) Institute] Institute of Information & Communications Technology Planning & Evaluation
[Research Project Name] Nurturing ICT and Broadcasting Innovation Talents
[Research Task Name] Artificial Intelligence Graduate School Support Project (Yonsei University)
[Project Performing Institute] University Industry Foundation, Yonsei University
[Research Period] 2024.01.01˜ 2024.12.31
[Project Serial No] 2710002082
[Project No] RS-2023-00240135
[Department] Ministry of Science and ICT
[Project management (Professional) Institute] National Research Foundation of Korea
[Research Project Name] Fundamental Technology Development Program
[Research Task Name] Development of Multiple CNT X-ray source based C-arm CT system with 3D spatial navigation for guiding image based robotic surgery
[Project Performing Institute] University Industry Foundation, Yonsei University
[Research Period] 2024.01.01˜ 2024.12.31

### DETAILED DESCRIPTION OF MAIN ELEMENTS

100: Low-dose computed tomography denoising neural network apparatus
110: Dose-aware network unit
120: Noise-variance calibration unit
130: Adaptive noise reduction unit
140: Controller
200: System structure of low-dose computed tomography denoising neural network apparatus system
210: Processor
230: Memory
250: User input/output unit
270: Network input/output unit
290: Communication port unit

What is claimed is:

1. A low-dose computed tomography (LDCT) denoising neural network apparatus comprising:
a dose-aware network unit that provides an LDCT image as an input image to a convolutional neural network (CNN) and outputs a simulated normal-dose computed tomography (NDCT) image as an output image;
a noise variance calibration unit that performs noise-variance calibration on the input image fed to the CNN to address the oversmoothing issue of the CNN; and
an adaptive noise reduction unit that controls the CNN to progressively remove the noise according to the dose level of a given LDCT image.

2. The apparatus of claim 1, wherein the dose-aware network unit pre-generates the LDCT image configured to have varying dose levels by adding noise to an NDCT image.

3. The apparatus of claim 2, wherein the dose-aware network unit generates the varying dose levels by adjusting the intensity of the noise by controlling an alpha parameter of the NDCT image.

4. The apparatus of claim 2, wherein the dose-aware network unit trains the CNN to minimize the discrepancy between the NDCT image and the simulated NDCT image.

5. The apparatus of claim 1, wherein the noise variance calibration unit adjusts the noise so that the detailed structure of the input image is preserved, based on the discrepancy between the output image and the input image.

6. The apparatus of claim 5, wherein the noise variance calibration unit adjusts the noise so that the output image has a noise variance higher than or equal to that of the NDCT image by a threshold.

7. The apparatus of claim 1, wherein the adaptive noise reduction unit recognizes the dose level of the given LDCT image through the CNN and progressively remove the noise by performing repeated input/output operation through the CNN.

8. The apparatus of claim 7, wherein the adaptive noise reduction unit inputs an N-th (where N is a natural number) intermediate image to the CNN to generate an (N+1)-th intermediate image and again inputs the (N+1)-th intermediate image to the CNN to generate an (N+2)-th intermediate image.

10. A low-dose computed tomography (LDCT) denoising neural network method performed in a LDCT denoising neural network apparatus, the method comprising:
a dose-aware network step that provides an LDCT image as an input image to a convolutional neural network (CNN) and outputs a simulated normal-dose computed tomography (NDCT) image as an output image;
a noise variance calibration step that performs noise-variance calibration on the input image fed to the CNN to address the oversmoothing issue of the CNN; and
an adaptive noise reduction step that controls the CNN to progressively remove the noise according to the dose level of a given LDCT image.
